(19) United States
(12) Patent Application Publication
(10) Pub. No.: US 2025/0068926 A1
(43) Pub. Date: Feb. 27, 2025

(54) FORGETFULNESS MECHANISM IN MULTI-TASK LEARNING

(71) Applicant: INTERNATIONAL BUSINESS MACHINES CORPORATION, ARMONK, NY (US)

(72) Inventors: VADIM RATNER, Haifa (IL); Yoel Shoshan, Haifa (IL)

(21) Appl. No.: 18/452,715

(22) Filed: Aug. 21, 2023

(51) Int. Cl. G06N 3/098

(52) U.S. Cl. CPC G06N 3/098

(57) ABSTRACT

A method, computer system, and a computer program product are provided. A neural network that includes multiple heads is trained. At least one auxiliary head of the multiple heads is identified. After completion of initial epochs of the training, a respective inverse gradient layer between the at least one auxiliary head and a feature extractor of the neural network is applied. Additional epochs of the training with the neural network and the inverse gradient layer are performed.

### BACKGROUND

The present invention relates generally to the fields of machine learning models, multi-task machine learning models, efficient training of machine learning models, of inference tasks performed by deep learning models, and performing health-related inference tasks by deep learning models.

### SUMMARY

According to one exemplary embodiment, a computer-implemented method is provided. A neural network that includes multiple heads is trained. At least one auxiliary head of the multiple heads is identified. After completion of initial epochs of the training, a respective inverse gradient layer between the at least one auxiliary head and a feature extractor of the neural network is applied. Additional epochs of the training with the neural network and the inverse gradient layer are performed. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment in which auxiliary task forgetfulness for training a deep learning model may be implemented according to at least one embodiment;

FIG. 2 is an operational flowchart illustrating a process for auxiliary task forgetfulness for training a deep learning model according to at least one embodiment;

FIG. 3A illustrates a machine learning pipeline for training a deep learning model in a first stage of the process of FIG. 2 according to at least one embodiment;

FIG. 3B illustrates a machine learning pipeline for training a deep learning model in a second stage of the process of FIG. 2 according to at least one embodiment;

FIG. 4 illustrates a plot of an embedding space which could benefit from the auxiliary task forgetfulness according to at least one embodiment; and

FIG. 5 illustrates a plot of another embedding space which could benefit from the auxiliary task forgetfulness according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

According to an aspect of the invention, a computer-implemented method includes training a neural network that includes multiple heads. At least one auxiliary head of the multiple heads is identified. After completion of initial epochs of the training, a respective inverse gradient layer is applied between the at least one auxiliary head and a feature extractor of the neural network. Additional epochs of the training are performed with the neural network and the inverse gradient layer. In this manner, many tasks can be used to help bolster the development of the feature extractor but then ultimately tasks that are unhelpful to the main task are forgotten by the feature extractor so that main task performance is prioritized. Irrelevant information from all of the training data may be forgotten rather than just forgetting all information learned from part of the data. Knowledge that dominates an embedding but is unhelpful to a main task is removed.

In at least some embodiments, a number of the initial epochs of the training is determined based on a pre-determined value. In this manner, training organization is streamlined based on a simplified solution of how the number of the initial epochs is selected.

In at least some embodiments, the training of the neural network is evaluated. A number of the initial epochs of the training is selected via identifying, based on the evaluating, a plateau in performance of the neural network. In this manner, training organization is optimized based on live data for more accuracy.

In at least some embodiments, the identifying of the at least one auxiliary head is pre-determined based on a respective correlation to a task of a main head of the neural network. In this manner, subject matter expertise is harnessed to optimize head characterization for training optimization.

In at least some embodiments, the identifying of the at least one auxiliary head includes (A) applying the inverse gradient layer between a first head of the multiple heads and the feature extractor and (B) evaluating an effect of the training caused by the applying of the inverse gradient layer between the first head and the feature extractor. In this manner, automated testing may be implemented to utilize live data to perform head characterization for training optimization.

In at least some embodiments, the identifying of the at least one auxiliary head further includes identifying the first head as at least part of the at least one auxiliary head in response to the evaluating indicating the affect is a decrease in performance of a main head of the neural network. In this manner, automated trial and error may be implemented to facilitate accurate head characterization for training optimization.

In at least some embodiments, the identifying of the at least one auxiliary head further includes identifying the first head as not part of the at least one auxiliary head in response to the evaluating indicating the affect is an increase or no change in performance of a main head of the neural network. In this manner, automated trial and error may be implemented to facilitate accurate head characterization for training optimization.

In at least some embodiments, the identifying of the at least one auxiliary head further includes (A) applying the inverse gradient layer between a second head of the multiple heads and the feature extractor, and (B) evaluating an effect of the training caused by the applying of the inverse gradient layer between the second head and the feature extractor. In this manner, automated trial and error may be implemented to facilitate accurate head characterization for training optimization.

According to an aspect of the invention, a computer system includes one or more processors, one or more computer-readable memories, and program instructions stored on at least one of the one or more computer-readable memories for execution by at least one of the one or more processors to cause the computer system to (A) train a neural network that includes multiple heads, (B) identify at least one auxiliary head of the multiple heads, (C) after completion of initial epochs of the training, apply a respective inverse gradient layer between the at least one auxiliary head and a feature extractor of the neural network, and (D) perform additional epochs of the training with the neural network and the inverse gradient layer. In this manner, a computer system is provided which performs many inference tasks during training to help bolster the development of the feature extractor but then ultimately forgets tasks that are unhelpful to the main task so that main task performance is prioritized. Irrelevant information from all of the training data may be forgotten rather than just forgetting all information learned from part of the data. Knowledge that dominates an embedding but is unhelpful to a main task is removed.

In at least some embodiments, a number of the initial epochs of the training performable by the computer system is determined based on a pre-determined value. In this manner, training organization is streamlined based on a simplified solution of how the number of the initial epochs is selected.

In at least some embodiments, program instructions of a computer system cause the computer system to evaluate the training of the neural network. A number of the initial epochs of the training is selected via identifying, based on the evaluating, a plateau in performance of the neural network. In this manner, training organization is optimized based on live data for more accuracy.

In at least some embodiments, the identifying of the at least one auxiliary head is pre-determined via the computer system based on a respective correlation to a task of a main head of the neural network. In this manner, subject matter expertise is harnessed to optimize head characterization for training optimization.

In at least some embodiments, the identifying of the at least one auxiliary head via the computer system includes (A) applying the inverse gradient layer between a first head of the multiple heads and the feature extractor and (B) evaluating an effect of the training caused by the applying of the inverse gradient layer between the first head and the feature extractor. In this manner, automated testing may be implemented to utilize live data to perform head characterization for training optimization.

In at least some embodiments, the identifying of the at least one auxiliary head via the computer system further includes identifying the first head as at least part of the at least one auxiliary head in response to the evaluating indicating the affect is a decrease in performance of a main head of the neural network. In this manner, automated trial and error may be implemented to facilitate accurate head characterization for training optimization.

In at least some embodiments, the identifying of the at least one auxiliary head via the computer system further includes identifying the first head as not part of the at least one auxiliary head in response to the evaluating indicating the affect is an increase or no change in performance of a main head of the neural network. In this manner, automated trial and error may be implemented to facilitate accurate head characterization for training optimization.

In at least some embodiments, the identifying of the at least one auxiliary head via the computer system further includes (A) applying the inverse gradient layer between a second head of the multiple heads and the feature extractor, and (B) evaluating an effect of the training caused by the applying of the inverse gradient layer between the second head and the feature extractor. In this manner, automated trial and error may be implemented to facilitate accurate head characterization for training optimization.

According to an aspect of the invention, a computer program product includes a computer-readable storage medium having program instructions embodied therewith. The program instructions are executable by a computer to cause the computer to (A) train a neural network that includes multiple heads, (B) identify at least one auxiliary head of the multiple heads, (C) after completion of initial epochs of the training, apply a respective inverse gradient layer between the at least one auxiliary head and a feature extractor of the neural network, and (D) perform additional epochs of the training with the neural network and the inverse gradient layer. In this manner, a computer program product is provided which facilitates the performance of many inference tasks during machine learning training to help bolster the development of the feature extractor but then ultimately forgets tasks that are unhelpful to the main task so that main task performance is prioritized. Irrelevant information from all of the training data may be forgotten rather than just forgetting all information learned from part of the data. Knowledge that dominates an embedding but is unhelpful to a main task is removed.

In at least some embodiments, a number of the initial epochs of the training performable according to the program instructions of the computer program product is determined based on a pre-determined value. In this manner, training organization is streamlined based on a simplified solution of how the number of the initial epochs is selected.

In at least some embodiments, program instructions of a computer program product cause a computer to evaluate the training of the neural network. A number of the initial epochs of the training is selected via identifying, based on the evaluating, a plateau in performance of the neural network. In this manner, training organization is optimized based on live data for more accuracy.

In at least some embodiments, the identifying of the at least one auxiliary head is pre-determined according to program instructions of a computer program product based on a respective correlation to a task of a main head of the neural network. In this manner, subject matter expertise is harnessed to optimize head characterization for training optimization.

In at least some embodiments, the identifying of the at least one auxiliary head according to program instructions of a computer program product includes (A) applying the inverse gradient layer between a first head of the multiple heads and the feature extractor and (B) evaluating an effect of the training caused by the applying of the inverse gradient layer between the first head and the feature extractor. In this manner, automated testing may be implemented to utilize live data to perform head characterization for training optimization.

In at least some embodiments, the identifying of the at least one auxiliary head according to program instructions of a computer program product further includes identifying the first head as at least part of the at least one auxiliary head in response to the evaluating indicating the affect is a decrease in performance of a main head of the neural network. In this manner, automated trial and error may be implemented to facilitate accurate head characterization for training optimization.

In at least some embodiments, the identifying of the at least one auxiliary head according to program instructions of a computer program product further includes identifying the first head as not part of the at least one auxiliary head in response to the evaluating indicating the affect is an increase or no change in performance of a main head of the neural network. In this manner, automated trial and error may be implemented to facilitate accurate head characterization for training optimization.

In at least some embodiments, the identifying of the at least one auxiliary head according to program instructions of a computer program product further includes (A) applying the inverse gradient layer between a second head of the multiple heads and the feature extractor, and (B) evaluating an effect of the training caused by the applying of the inverse gradient layer between the second head and the feature extractor. In this manner, automated trial and error may be implemented to facilitate accurate head characterization for training optimization.

The following described exemplary embodiments provide a computer system, a method, and a computer program product for improving training of a machine learning model so that a variety of tasks are harnessed during training to improve the development of a feature extractor which fills the embedding space, but that ultimately tasks that are unhelpful to a main task are gradually forgotten via the feature extractor. The system and method described herein also help differentiate in an automated manner between features that are helpful to a main task and features that are unhelpful to a main task of a multi-head machine learning model. A multi-head machine learning model includes a central feature extractor, e.g., encoder, which receives input and, in response to receiving the input, produces vector representations of the input in an embedding space. The vector representations are output to multiple auxiliary branches each of which performs a separate inference task. Each of the auxiliary branches may be referred to as a respective head of the multi-head model. By adding multiple heads, the embedding space is improved by allowing more data to be used and to pass through the feature extractor. For example, if a main task evaluates disease onset and/or health event prediction and secondary tasks which predict gender, age, next visit, and/or a prescription are used to jump-start the learning process of the machine learning model, any irrelevant knowledge for the main task may eventually gradually be removed via implementation of the methods and features described herein. Thus, a jump-start of feature extractor development may be achieved while still ultimately narrowing in on main task performance for the machine learning model so that extraneous information does not distract the machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as multi-head model auxiliary branch forgetfulness program 116. In addition to multi-head model auxiliary branch forgetfulness program 116, computing environment 100 includes, for example, computer 101, wide area network (WAN) 102, end user device (UJI)) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and multi-head model auxiliary branch forgetfulness program 116, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

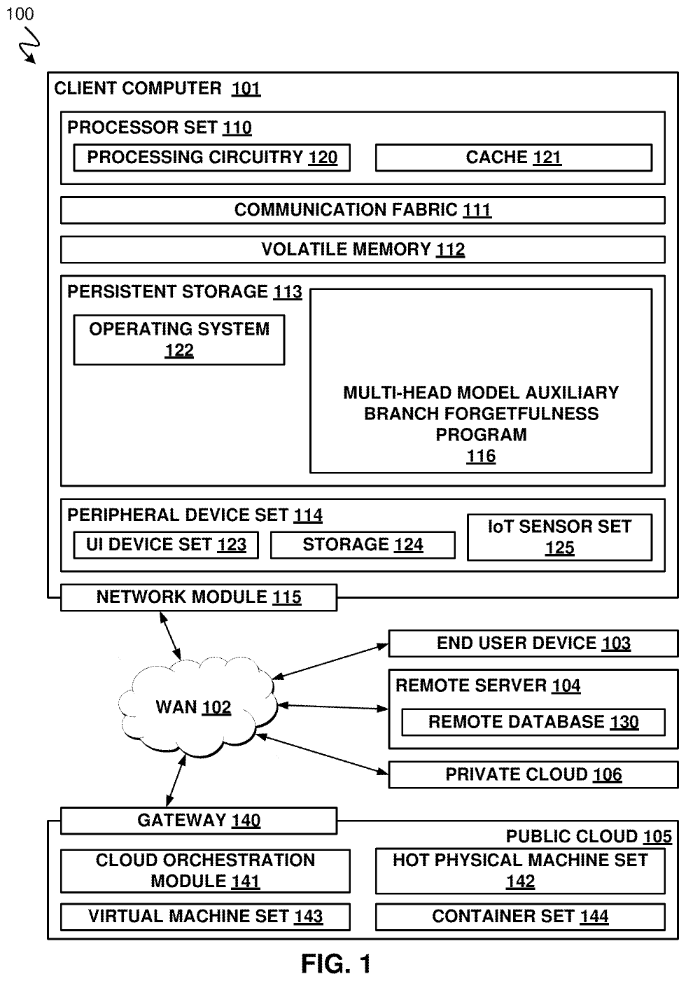

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in multi-head model auxiliary branch forgetfulness program 116 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in multi-head model auxiliary branch forgetfulness program 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USE) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing exceptionally large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EU D 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares. CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

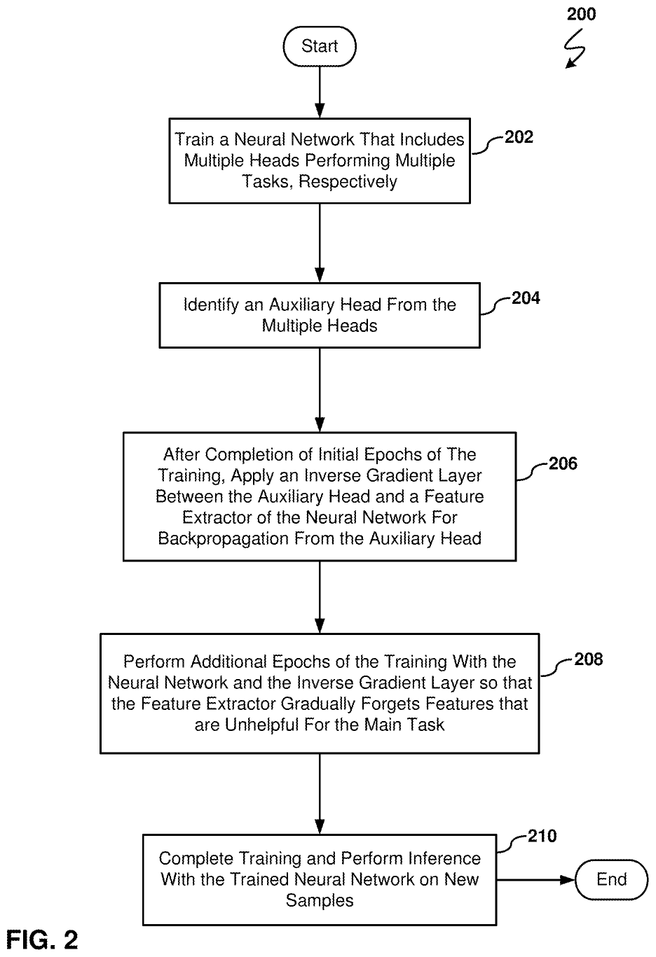

FIG. 2 illustrates an operational flowchart illustrating a multi-head model auxiliary branch forgetting process 200 for training a deep learning model to perform inference.

In step 202 of the multi-head model auxiliary branch forgetting process 200 shown in FIG. 2, a neural network that includes multiple heads performing multiple tasks, respectively, is trained. The multi-head model auxiliary branch forgetfulness program 116 shown in FIG. 1 performs the training of step 202 in at least some embodiments. The training includes receiving training data, inputting the training data into the multi-head machine learning model, and updating the model based on results. The multi-head machine learning model in some embodiments is within the multi-head model auxiliary branch forgetfulness program 116 in computer 101 shown in FIG. 1. The multi-head machine learning model in some embodiments is within another computer such as the remote server 104 with which the multi-head model auxiliary branch forgetfulness program 116 in computer 101 wirelessly communicates via the WAN 102 as shown in FIG. 1. A transformer neural network includes an encoder and a decoder. The encoder receives an input and, in response to receiving the input, transforms the input into a vector representation based on an embedding space. The vector representation is output from the encoder and is input into one or more decoders that are heads of the transformer. Each separate head or decoder is configured to analyze the vector representation in a way to achieve some task such as an inferencing task. Inferencing tasks such as but not limited to classification and segmentation may be performed via a respective head. For example, based on patient data one head could predict possibility of a patient having or developing a certain disease. Another head of the same multi-head model could analyze patient data to predict how old a patient is. The same vector representation could be submitted as input to each of these two heads and then the heads would separately analyze the vector representations to perform their inferencing task.

By using multiple heads to respectively perform multiple tasks during training, the encoder or feature extractor becomes more informed and diverse and learns more knowledge about the one or more domains in question. Each individual head performs its own task better by being exposed to the greater variety of tasks.

Training a neural network includes inputting training data into the neural network. For supervised training, groundtruth labels for the training data exist and can be compared to the inferences of the various heads. For forward propagation during training, the inputs are transformed via the encoder/feature extractor into a vector representation and then the vector representation is input into each of the various heads. The various heads may be referred to as branches of the multi-head neural network. The various heads analyze the vector representation and perform an inferencing task on the received vector representation. Training also includes backpropagation in which weights of the layers of the feature extractor and the various heads are updated based on the success of the previous inference. The success refers to a comparison of the groundtruth labels with the actual inference of the previous round. A difference between the actual inference and the groundtruth labels is passed backwards through the layers and the weights of the layers are updated along the way. Each of the separate heads will have its own groundtruth label for the comparison, so weights of the layers of each head will be adjusted separately. The weights of the layers of the feature extractor are updated to help the feature extractor identify and find features will help each of the various heads perform their tasks effectively. For unsupervised training, the target output is set at each stage of the algorithm to the class for which the average distance before updating is the smallest. The neural network is trained to place its input into the class whose members are most similar in terms of the input. To protect against input scale sensitivities, in some embodiments input data is normalized in each dimension by subtracting an average and dividing by a standard deviation for each component to calculate a distance in a scale-invariant manner.

In step 204 of the multi-head model auxiliary branch forgetting process 200 shown in FIG. 2, an auxiliary head from the multiple heads is identified. Different embodiments allow for different modes of performing the identification of step 204. The multiple heads refers to the multiple heads of the neural network that is being trained in step 202. In at least some embodiments, the multi-head model auxiliary branch forgetfulness program 116 in computer 101 is involved in the identification of step 204. In some embodiments, the multi-head model auxiliary branch forgetfulness program 116 in computer 101 will perform various steps as an automated identification of an auxiliary branch. In other embodiments, the multi-head model auxiliary branch forgetfulness program 116 in computer 101 receives input from an input device such as a keyboard connected to the computer 101 and a selection of one or more of the heads as an auxiliary branch occurs via user input received via the input device.

In some embodiments, the identifying of the at least one auxiliary head of step 204 is pre-determined based on a respective correlation to a task of a main head of the neural network. In this manner, subject matter expertise is harnessed to optimize head characterization for training optimization. For example, a subject matter expert who is guiding the training of the machine learning model selects which of the various heads is the main head or main-task closely related heads and which are auxiliary heads. This selection in some embodiments is performed based on a correlation of the tasks of the various other heads to the task of the main head. For example, if a task has a similarity value compared to a main task and the similarity value is greater than a threshold value, then the task is considered closely related and helpful for the main task. If a task has a similarity value compared to a main task and the similarity value is less than a threshold value, then the task is considered unhelpful for the main task and is an auxiliary branch. In one example, a main task for a main head of a multi-head neural network is to predict Parkinson's disease onset, a task of a second head of the multi-head neural network is to predict neurodegenerative disease onset, and the task of the second head is considered to be sufficiently similar that the second head is helpful for the main task. In another example, a main task for a main head of a multi-head neural network is to predict Parkinson's disease onset, a task of a second head of the multi-head neural network is to predict age of a patient, and the task of the second head is considered to be sufficiently dissimilar that the second head is determined to be unhelpful for the main task. Thus, in this example the second head is identified as an auxiliary branch.

In at least some embodiments, the identifying of the at least one auxiliary head includes (A) applying the inverse gradient layer between a first head of the multiple heads and the feature extractor and (B) evaluating an effect of the training caused by the applying of the inverse gradient layer between the first head and the feature extractor. In this manner, automated testing may be implemented to utilize live data to perform head characterization for training optimization. If the evaluating indicates that the affect is a decrease in performance of a main head of the neural network, then the first head is considered important for the main task and the first head is not identified as an auxiliary branch. If the evaluating indicates the affect is an increase or no change in performance of a main head of the neural network, then the first head is considered to be unimportant or unhelpful for the task of the main head and the first head is considered an auxiliary branch. In this manner, automated trial and error may be implemented to facilitate accurate head characterization for training optimization. In at least some embodiments the multi-head model auxiliary branch forgetfulness program 116 in computer 101 performs this automated trial and error of identifying which of the multi-heads are auxiliary heads that are unhelpful and/or unimportant for a main task. The same trial and error in some embodiments is applied to a second head of the multi-head model and subsequently to each of the other heads of the multi-head model.

In at least some embodiments, the identifying of the at least one auxiliary head includes identifying any head of the multi-head neural network that is not the main head. Under this approach, an input is provided, e.g., via an input device to the computer 101, to identify the main head. In response, the multi-head model auxiliary branch forgetfulness program 116 in computer 101 considers every other head as an auxiliary branch. As explained below, in this embodiment a false choice of an auxiliary branch being unhelpful/unimportant is ultimately unharmful because the gradients applied during backpropagation control whether the other branches are turned off for the feature extractor or not.

In step 206 of the multi-head model auxiliary branch forgetting process 200 shown in FIG. 2, after completion of initial epochs of the training an inverse gradient layer is applied between the auxiliary head and a feature extractor of the neural network for backpropagation from the auxiliary head. The auxiliary head refers to the head that was identified in step 204.

Different embodiments include different methods for determining a number of the initial epochs that are referred to in step 206. In some embodiments, the number of the initial epochs for the first stage of the training is determined based on a pre-determined value, e.g., is heuristic. For example, the number is twenty, twenty-five, thirty, thirty-five, forty, or another similar number of epochs. In one embodiment, the number is between the range of twenty-five to thirty-five epochs. In this manner, training organization is streamlined based on a simplified solution of how the number of the initial epochs is selected.

In some embodiments, the number of the initial epochs of the training is selected via identifying, based on the evaluating, a plateau in performance of the neural network. Backpropagation during training helps improve model performance and performance of the main task, e.g., the task of the main branch. For each epoch, a loss is determined via comparing an inference output with a groundtruth value. By adjusting the weights of the neural network model, the inference outputs improve and for subsequent epochs can move closer to groundtruth values. The loss values can be tracked to evaluate the performance of the model. In at least some embodiments, the recognition of a plateau in the performance and in the loss values indicates that the first stage of training is sufficient so that the second stage with application of an inverse gradient layer begins. In some embodiments, the plateau refers to a performance value having a constant or near-constant value over repeated iterations. In some embodiments, the performance is considered to have reached a plateau if the change in the performance value, whether via a positive or negative change, is smaller than a pre-determined threshold value, e.g., over a pre-determined threshold time value or over a pre-determined threshold number of iterations. For example, in some embodiments the performance is considered to have reached a plateau if the change in the performance value, whether via a positive or negative change, is three percent or less compared to the overall performance value over five or more additional iterations of the training with a respective additional epoch of training data. Thus, some positive or negative fluctuations that are small or extremely small are still acceptable for the performance trend to be in a plateau. In some embodiments, a plateau is considered to encompass a changing performance value if the rate of change in the performance value is less than a pre-determined threshold value. In this manner with the plateau comparison, training organization is optimized based on live data for more accuracy.

After the initial epochs are completed, for step 206 an inverse gradient layer is applied along the backpropagation route between the one or more identified auxiliary branches and the feature extractor/encoder of the neural network transformer model. The inverse gradient layer also known as a gradient reversal layer includes neurons configured to multiply the gradient by a certain negative constant during the backpropagation. Thus, with this inverse gradient layer the typical gradient

$$\frac{\partial {L}_{d}}{\partial {θ}_{f}}$$

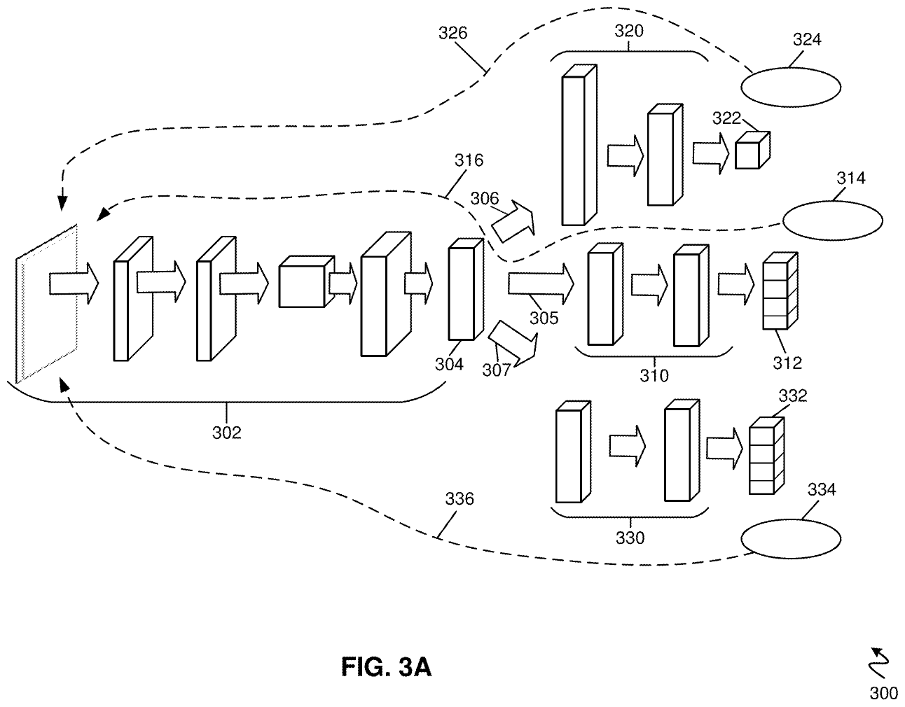

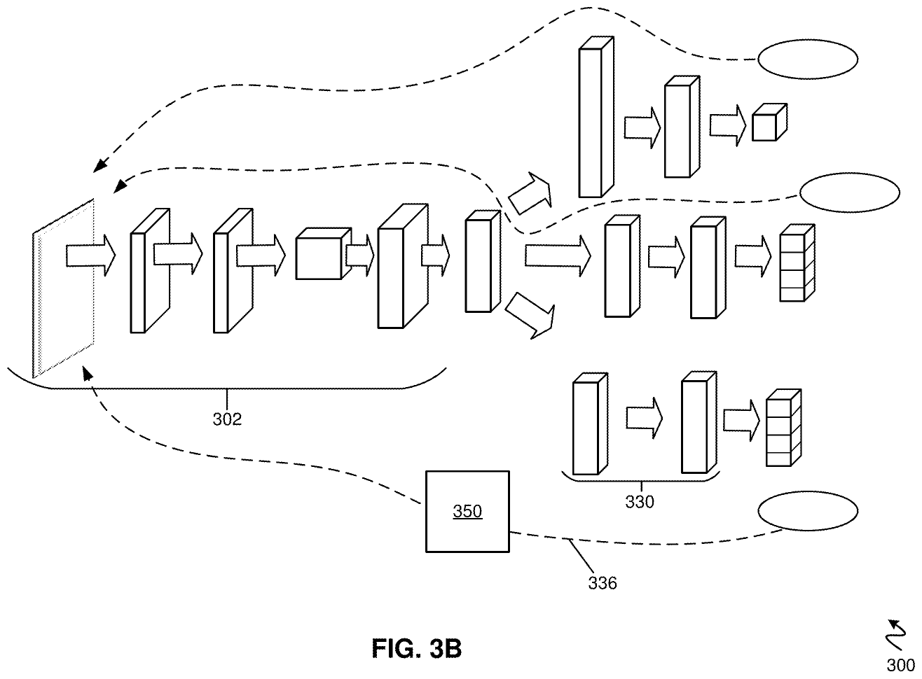

(for a loss L_{d} for an auxiliary task d and f referring to a feature of the feature extractor) becomes

$$- λ \frac{\partial {L}_{d}}{\partial {θ}_{f}}$$

where λ is the constant. FIG. 3B shows this gradient reversal layer being applied along the backpropagation path between the auxiliary path and the feature extractor portion of the transformer neural network model.

In step 208 of the multi-head model auxiliary branch forgetting process 200 shown in FIG. 2, additional epochs of the training are performed with the neural network and the inverse gradient layer so that the feature extractor gradually forgets features that are unhelpful for the main task. The inverse gradient layer refers to the inverse gradient layer that was applied in step 206. In at least some embodiments, a number of the additional epochs performed in step 208 is greater than the number of the initial epochs that were performed for first stage, e.g., before step 206 and the application of the inverse gradient layer. For supervised training for the additional epochs, training data with groundtruth labels are also input into the multi-head neural network model. Due to the inverse gradient layer and the negative constant that is thereby applied, the feature extractor is caused to forget features that are important to the task of the auxiliary branch. Weights for these features are reduced and devalued. However, features important for the task of the main head are emphasized and strengthened within the weights of the feature extractor during the backpropagation from the main head. If certain features are important in the auxiliary branch with the inverse gradient layer and also important for the task of the main head, these become opposing forces. These opposing forces help the neural network become optimized to value and recognize the most important features for the main task. The feature encouragement from the main head can override the forgetting effect from the auxiliary head if the feature is indeed helpful to the task of the main head. If a feature or group of features is important for the task of the auxiliary head and is/are not important for the task of the main head, then the inverse gradient layer will gradually cause the feature extractor to forget these features for the feature vector representation that it produces as output.

In step 210 of the multi-head model auxiliary branch forgetting process 200 shown in FIG. 2, the training is completed and inference with the trained neural network is performed on new samples. The training refers to that training being performed in steps 202, 206, and 208. After the training phase of a neural network is completed, the trained network is used to make inferences for new samples. A new sample is input into the trained neural network. In response to the inputting, the trained neural network generates, as output, an inference related to the sample. For example, for the trained neural network whose main task is to predict Parkinson's disease onset based on patient data, a new sample of patient data is input into the trained neural network and the trained neural network provides a prediction as to the chances of that patient experiencing Parkinson's disease in the future. In some embodiments, the inference is performed exclusively for a main head of the initial multi-head model. For example, auxiliary branches/heads are removed from the multi-head model before the inference stage. In other embodiments, the auxiliary branches/heads remain with the multi-head model so that multiple inferences are generated during the inference stage—with a respective inference for each of the heads. The inference of step 210 may be involved in disease modeling, drug design, and/or other fields.

FIGS. 3A and 3B together illustrate aspects of training a multi-head neural network transformer model and also implementing the feature forgetting mechanism described herein. FIG. 3A illustrates a first stage in which training is performed for initial epochs of training data. FIG. 3B illustrates a second stage in which training is performed for additional epochs of training data after one or more inverse gradient layers are applied. FIG. 3A shows a multi-head transformer neural network 300. The multi-head transformer neural network 300 includes a feature extractor 302 and multiple heads including a main head 310, a first auxiliary head 320, and a second auxiliary head 330. The feature extractor 302 receives an input sample and, in response, produces a vector representation 304 that represents particular features of the input sample. The vector representation 304 is output of the feature extractor 302 and is input to each of the multiple heads of the multi-head transformer neural network 300. FIG. 3A shows that the vector representation 304 is input into the main head 310 via a first connecting path 305, is input into the first auxiliary head 320 via a second connecting path 306, and is input into second auxiliary head 330 via a third connecting path 307. Each of the multiple heads performs a respective inferencing task and produces a respective inference. A first inference 312 is produced as output via the main head 310. A second inference 322 is produced as output via the first auxiliary head 320. A third inference 332 is produced as output via the second auxiliary head 330. During a training phase of the multi-head transformer neural network 300, input samples have groundtruth labels and the various inferences that are produced are comparable to the groundtruth labels. Comparing a groundtruth label for a first sample to the first inference 312 produces a first loss 314. Comparing a groundtruth label for a sample to the second inference 322 produces a second loss 324. Comparing a groundtruth label for a sample to the third inference 312 produces a third loss 334. These various losses are used during backpropagation to update the weights of the layers of the various heads and also of the feature extractor 302. A first backpropagation path 316 is shown running between the first loss 314 and an input side of the feature extractor 302. A second backpropagation path 326 is shown running between the second loss 324 and an input side of the feature extractor 302. A third backpropagation path 336 is shown running between the third loss 334 and an input side of the feature extractor 302.

During initial epochs of the training performed for the multi-head transformer neural network 300, backpropagation gradients are used along each of the first, second, and third backpropagation paths 316, 326, and 336, respectively, so that weights of the feature extractor 302 are adjusted to help each of the various heads to better perform their respective inferences.

FIG. 3B shows the multi-head transformer neural network 300 after an inverse gradient layer 350 is applied in the third backpropagation path 336. This inverse gradient layer 350 is applied between the second auxiliary head 330 and the feature extractor 302. Due to the negative constant applied in the inverse gradient layer 350, features that are important for the second auxiliary head 330 are penalized when applied to the feature extractor 302 during the backpropagation. Therefore, as more of the additional epochs are performed during this second stage of the training the feature extractor will gradually forget the important features for this second auxiliary head 330 unless these features are also important for the task of the main head 310. In that instance the weight adjustment via the first backpropagation path 316 can and/or do outweigh the weight adjustment via the inverse gradient layer 350 of the third backpropagation path 336. If these features are neutral or unimportant for the task of the main head 310 the feature extractor 302 will gradually forget those features due to the penalization from the inverse gradient layer 350.

Although FIGS. 3A and 3B show two auxiliary heads, in various embodiments a neural network transformer model has more than two auxiliary heads, e.g., three, four, five, six, or more auxiliary heads. Although FIG. 3B shows an inverse gradient layer being applied for only one of the auxiliary heads, in various embodiments a respective inverse gradient layer is applied to all, most, or some of the auxiliary heads. The application of the respective inverse gradient layers in some embodiments occur simultaneously. In other embodiments, the application of the respective inverse gradient layers occur sequentially, e.g., one at a time.

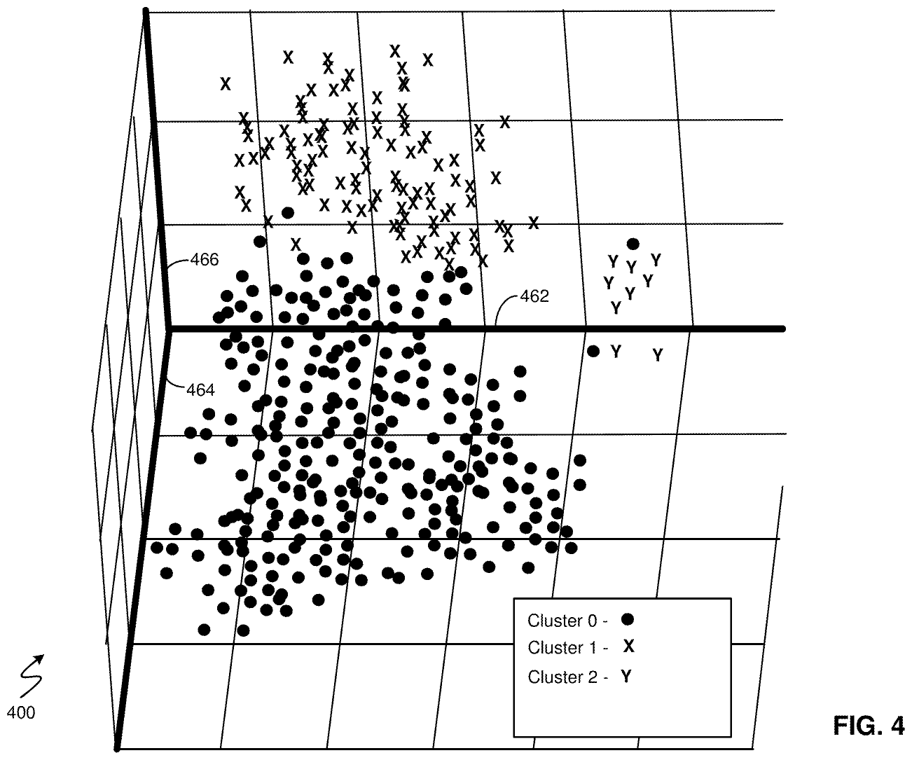

FIG. 4 illustrates a plot of a first embedding space 400 that according to at least one embodiment represents a group of input data used to train a multi-head neural network transformer. For simplicity, the first embedding space 400 is depicted with three axes—an x-axis 462, a y-axis 464, and a z-axis 466. Although in practice, the various embedding spaces involved often have far more than three dimensions, e.g., have around seventy dimensions. FIG. 4 illustrates an instance when auxiliary branch forgetfulness would be helpful. The first embedding space 400 represents a model intended to be trained to make inferences regarding Parkinson's disease phenotyping. Auxiliary tasks were added, however, to help bolster the feature extractor to be familiar with a greater variety of features. An auxiliary head for next visit prediction was added to the multi-head neural network transformer.

The first embedding space 400 illustrates a clear division into diabetes/non-diabetes/common diabetes complications. The cluster 0 represented patient data without diabetes mellitus. The cluster 1 represented patient data with diabetes mellitus. The cluster 2 represented patient data with no fluid and electrolyte disorders, medical supplies and devices, with dialysis, other microbiology tests, no allergic reactions, case management services, and coagulation and hemorrhagic disorders.

By applying the inverse gradient layer between the auxiliary branch and the feature extractor that produced the first embedding space 400, any feature that is unhelpful to the task of the main head may be gradually forgotten.

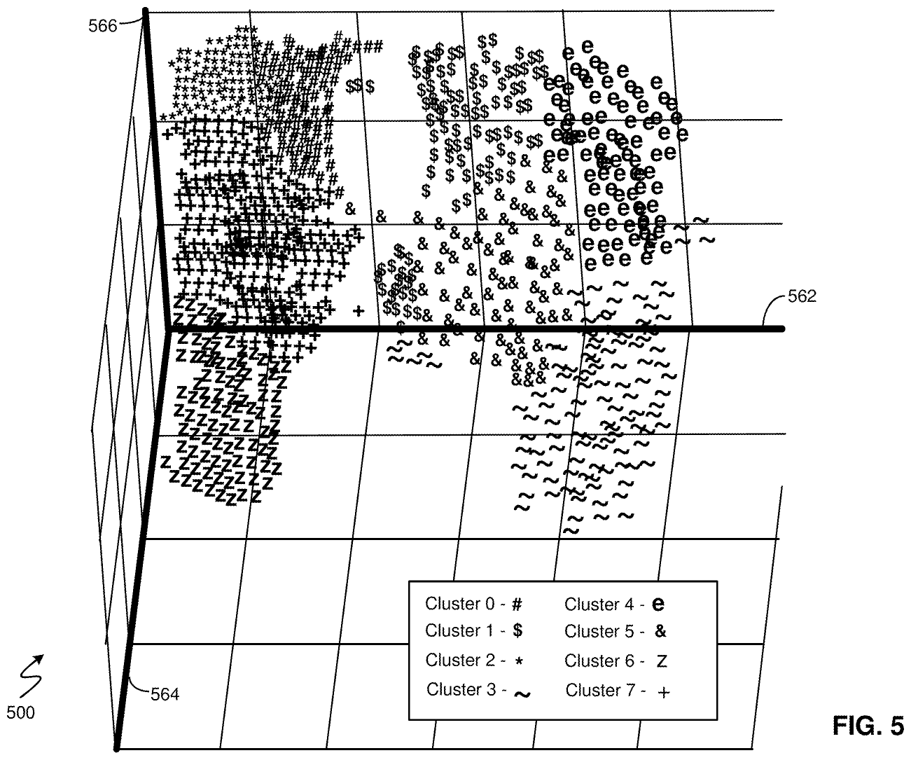

FIG. 5 illustrates a plot of a second embedding space 500 that according to at least one embodiment represents a group of input data used to train a multi-head neural network transformer. The second embedding space 500 is depicted with three axes—an x-axis 562, a y-axis 564, and a z-axis 566. Although in practice, the various embedding spaces involved often have far more than three dimensions.

FIG. 5 illustrates an instance when auxiliary branch forgetfulness would be helpful. The second embedding space 500 represents a model intended to be trained to make inferences regarding Parkinson's disease phenotyping. Auxiliary tasks were added, however, to help bolster the feature extractor to be familiar with a greater variety of features. Respective auxiliary heads for next visit prediction and for gender prediction were added to the multi-head neural network transformer.

The second embedding space 500 illustrates a clear division into diabetes/non-diabetes/common diabetes complications. Clusters 0 and 2 represented clusters for male patients. Clusters 1, 3, 4, and 5 represented clusters for female patients. Clusters 0 and 1 also represented patients with developmental disorders. Clusters 2, 3, 4, and 5 represented patients with diabetes mellitus. Cluster 5 represented patients that were older than 84 years old. The cluster divisions in the second embedding space 500 are possibly not relevant for Parkinson's disease phenotyping.

By applying a respective inverse gradient layer between each auxiliary branch and the feature extractor that produced the second embedding space 500, any feature that is unhelpful to the task of the main head may be gradually forgotten.

It may be appreciated that FIGS. 1-5 provide only illustrations of certain embodiments and do not imply any limitations with regard to how different embodiments may be implemented. Many modifications to the depicted embodiment(s), e.g., to the particular steps and/or order of the depicted method, may be made based on design and implementation requirements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
training a neural network that includes multiple heads;
identifying at least one auxiliary head of the multiple heads;
after completion of initial epochs of the training, applying a respective inverse gradient layer between the at least one auxiliary head and a feature extractor of the neural network; and
performing additional epochs of the training with the neural network and the inverse gradient layer.

2. The computer-implemented method of claim 1, wherein a number of the initial epochs of the training is determined based on a pre-determined value.

3. The computer-implemented method of claim 1, further comprising evaluating the training of the neural network; wherein a number of the initial epochs of the training is determined via identifying, based on the evaluating, a plateau in performance of the neural network.

4. The computer-implemented method of claim 1, wherein the identifying of the at least one auxiliary head is pre-determined based on a respective correlation to a task of a main head of the neural network.

5. The computer-implemented method of claim 1, wherein the identifying of the at least one auxiliary head comprises:
applying the inverse gradient layer between a first head of the multiple heads and the feature extractor; and
evaluating an effect of the training caused by the applying of the inverse gradient layer between the first head and the feature extractor.

6. The computer-implemented method of claim 5, wherein the identifying of the at least one auxiliary head further comprises identifying the first head as at least part of the at least one auxiliary head in response to the evaluating indicating the affect is a decrease in performance of a main head of the neural network.

7. The computer-implemented method of claim 5, wherein the identifying of the at least one auxiliary head further comprises identifying the first head as not part of the at least one auxiliary head in response to the evaluating indicating the affect is an increase or no change in performance of a main head of the neural network.

8. The computer-implemented method of claim 7, wherein the identifying of the at least one auxiliary head further comprises:
applying the inverse gradient layer between a second head of the multiple heads and the feature extractor; and
evaluating an effect of the training caused by the applying of the inverse gradient layer between the second head and the feature extractor.

9. A computer system comprising:
one or more processors, one or more computer-readable memories, and program instructions stored on at least one of the one or more computer-readable memories for execution by at least one of the one or more processors to cause the computer system to:
train a neural network that includes multiple heads;
identify at least one auxiliary head of the multiple heads;
after completion of initial epochs of the training, applying a respective inverse gradient layer between the at least one auxiliary head and a feature extractor of the neural network; and
perform additional epochs of the training with the inverse gradient layer.

10. The computer system of claim 9, wherein a number of the initial epochs of the training is determined based on a pre-determined value.

11. The computer system of claim 9, wherein the program instructions are for execution to cause the computer system to evaluate the training of the neural network, and wherein a number of the initial epochs of the training is determined via identifying, based on the evaluating, a plateau in performance of the neural network for the main head.

12. The computer system of claim 9, wherein the identifying of the at least one auxiliary head is pre-determined based on a respective correlation to a task of a main head of the neural network.

13. The computer system of claim 9, wherein the identifying of the at least one auxiliary head comprises:
applying the inverse gradient layer between a first head of the multiple heads and the feature extractor; and
evaluating an effect of the training caused by the applying of the inverse gradient layer between the first head and the feature extractor.

14. The computer system of claim 13, wherein the identifying of the at least one auxiliary head further comprises identifying the first head as at least part of the at least one auxiliary head in response to the evaluating indicating the affect is a decrease in performance of a main head of the neural network.

15. A computer program product comprising a computer-readable storage medium having program instructions embodied therewith, the program instructions executable by a computer to cause the computer to:
train a neural network that includes multiple heads;
identify at least one auxiliary head of the multiple heads;
after completion of initial epochs of the training, applying a respective inverse gradient layer between the at least one auxiliary head and a feature extractor of the neural network; and
perform additional epochs of the training with the neural network and the inverse gradient layer.

16. The computer program product of claim 15, wherein a number of the initial epochs of the training is determined based on a pre-determined value.

17. The computer program product of claim 15, wherein the program instructions are for execution to cause the computer system to evaluate the training of the neural network, and wherein a number of the initial epochs of the training is determined via identifying, based on the evaluating, a plateau in performance of a main head of the neural network.

18. The computer program product of claim 15, wherein the identifying of the at least one auxiliary head is pre-determined based on a respective correlation to a task of a main head of the neural network.

19. The computer program product of claim 15, wherein the identifying of the at least one auxiliary head comprises:
applying the inverse gradient layer between a first head of the multiple heads and the feature extractor; and
evaluating an effect of the training caused by the applying of the inverse gradient layer between the first head and the feature extractor.

20. The computer program product of claim 19, wherein the identifying of the at least one auxiliary head further comprises identifying the first head as at least part of the at least one auxiliary head in response to the evaluating indicating the affect is a decrease in performance of a main head of the neural network.
